(19) United States
(12) Patent Application Publication
(10) Pub. No.: US 2005/0268976 A1
(43) Pub. Date: Dec. 8, 2005

(54) Single-controlled flow reversing valve

(76) Inventor: Dacio Mucio De Souza, Sao Paulo (BR)

Correspondence Address: DICKINSON WRIGHT PLLC, 1901 L. STREET NW, SUITE 800, WASHINGTON, DC, 20036, US

(21) Appl. No.: 10/860,674

(22) Filed: Jun. 3, 2004

(51) Int. Cl. F16K 11/16

(52) U.S. Cl. 137/868

(57) ABSTRACT

The present report relates to a single-controlled flow reversing valve and, more specifically, to a device to be adapted to tanks for water filtering, as well as other similar purposes.

### BACKGROUND OF THE INVENTION

1. Field of the Invention

The present invention relates to a single-controlled flow reversing valve and, more specifically, to a device to be adapted to tanks for water filtering, as well as other similar purposes.

2. Description of the Related Art

Some pieces of equipment are currently known, which make use of other technologies for flow reversion, some of which are electronically or electrically controlled while others are mechanically controlled. Such equipment performs flow reversion horizontally, by means of ball valves or gate valves. In these cases, the operator must operate several stopcocks (a mechanical device to open or close flow) to complete reversion. Such practice has been proving to be disadvantageous and inconvenient, as it may induce the operator to operate incorrectly, preventing the equipment from working well, and also, some of these are very expensive.

### BRIEF SUMMARY OF THE INVENTION

Thus, the general object of the present innovation is to provide an improvement over known reversing valves used in tanks for water filtering and similar purposes with a specifically developed device. The present invention enables the user to operate flow variation by handling a single handle, which is external to the module, reversing the flow by means of a shaft equipped with three duly spaced and fixed cams, each one of those with a different profile, according to the flow reversion order, which cams, when radially moved by the shaft connected to the handle, start respective plungers, which open certain ways and close others, thus providing the desired reversion.

### BRIEF DESCRIPTION OF THE DRAWINGS

The present invention will be more fully understood by reference to the following detailed description of the preferred embodiments of the present invention when read in conjunction with the accompanying drawings, in which like reference characters refer to like parts throughout the views, and in which:

FIG. 1 is a top plan view of the intermediate block of the present invention;

FIG. 2 is a side elevational and sectional view of the operative elements of the upper cap of the present invention;

FIG. 3 is a top plan and sectional view of the operative elements of the upper cap of the present invention;

FIG. 4 is a sectional view of the present invention taken along lines 4-4 of FIG. 1 illustrating the intermediate block and the lower cap; and

FIG. 5 is a sectional view of the present invention taken along lines 5-5 of FIG. 1 illustrating the intermediate block and the lower cap.

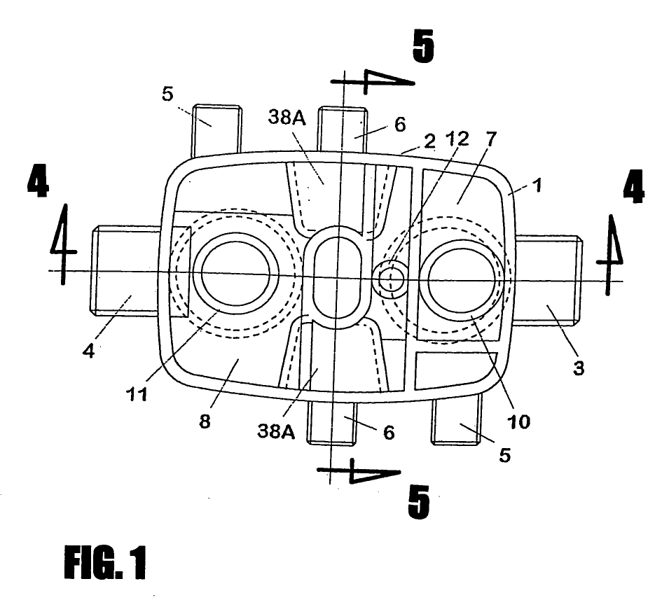

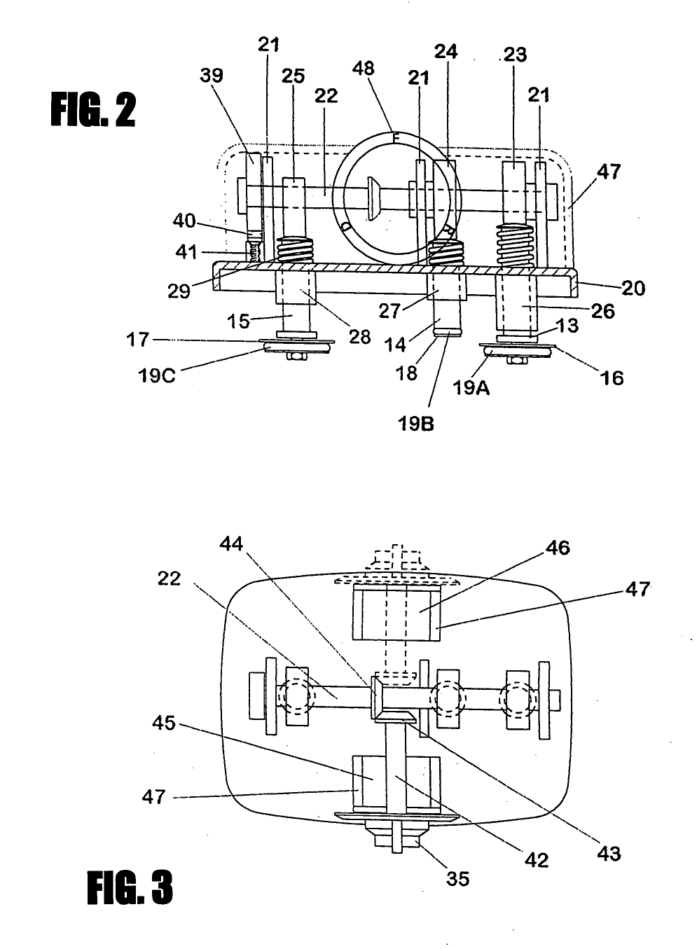

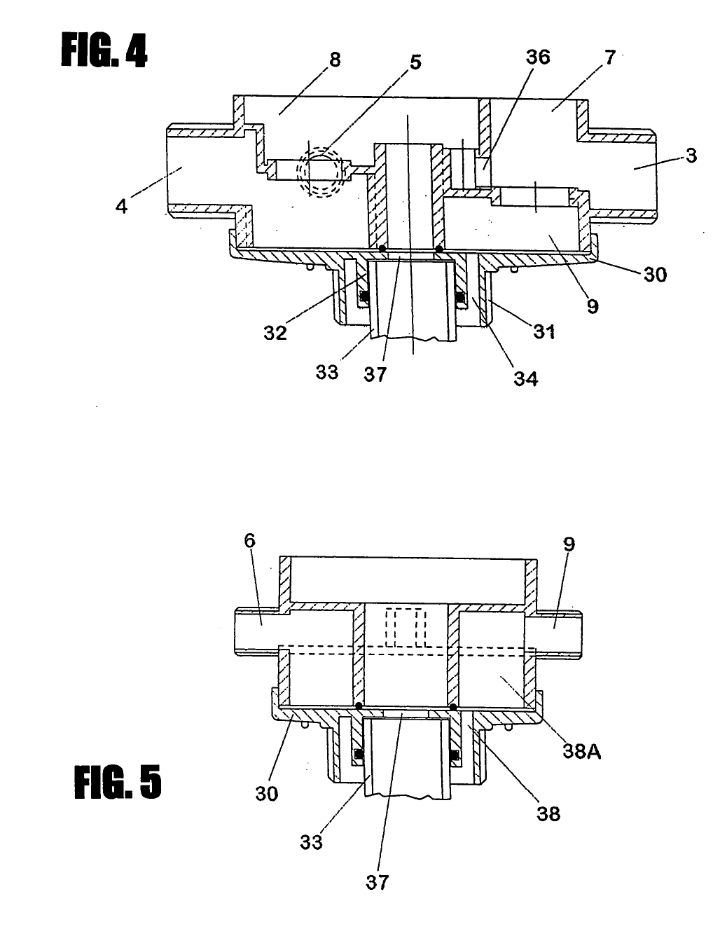

### DETAILED DESCRIPTION OF THE PREFERRED EMBODIMENT

The drawings disclose the preferred embodiments of the present invention. While the configurations according to the illustrated embodiment are preferred, it is envisioned that alternate configurations of the present invention may be adopted without deviating from the invention as portrayed. The preferred embodiments are discussed hereafter.

According to the illustrations, the referred valve is basically defined by an intermediate block (1), preferably built in reinforced plastic matter, substantially parallelepipedally shaped, with four slightly radial faces (2), each one equipped with tubular projections (3), (4), (5) and (6), externally threaded. This intermediate block (1) has internal isolated divisions named chambers (7), (8) and (9), out of which small cylindrical extensions (10), (11) and (12) come, which extensions, opened or closed by respective plungers (13), (14) or (15), are the ones that determine the water flow or the like. The cylindrical extensions (10), (11) and (12) said above are the housings where the flanges (16), (17) and (18), fixed on the plungers (13), (14) or (15) ends, and provided with O-rings (19A), (19B) and (19C), are fitted in upon plungers (13), (14) or (15) driving, respectively, thus opening or closing the cylindrical extensions (10), (11) or (12), driving the flow.

The intermediate block (1) is closed, on the upper end, by a cap (20), which follows the intermediate block (1) profile. On the upper cap (20) are, externally, the shaft (22) bearings (21), equipped with three cams (23), (24) and (25), respectively aligned with corresponding plungers (13), (14) or (15), which plungers are mounted internally to tubular projections (26), (27) and (28), located on the upper cap (20) lower and internal portion, and the same plungers (13), (14) and (15) are driven downwards by the respective cams (23), (24) and (25), and upwards by means of springs (29), respectively. The intermediate block (1) is also closed on the lower portion by another cap, named lower cap (30), which also follows said intermediate block (1) profile. It has, on its central portion, a cylindrical tubular projection, externally threaded (31), where coupling with the tank is made, and this tubular projection (31) also has, internally, a housing (32), for a tube (33), which will extend up to the tank bottom, and, on the external portion of this housing (32), there are openings (34), through which the water passage or the like will be made, from up downwards, for filtration.

To make the valve operation clearer, when the handle (35) is handled, where a shaft (42) is connected, which has a corresponding conic gear (44) fixed to it, which is fixed to the shaft (22), makes it rotate, driving the cams (23), (24) and (25), obtaining the following flow configurations:
13 (closed), 14 (open) and 15 (closed)=Backwash,
13 (open), 14 (closed) and 15 (closed)=Drainage,
13 (open), 14 (closed) and 15 (open)=Filtration.

The assembly composed of handle (35), shaft (42) and conic gear (43) is movable, and, according to the place where it is required to install the valve, it may have its installation position reversed to one side (45) or to the other (46), simply fitting it into the tracks (47), and sliding it until the conic gear (43) is coupled to the corresponding conic gear (44).

Based on the above description, the valve operates as follows: The water enters the chamber (7), through the tubular projection (3), with the plunger (13) in the open position, the water passes through the cylindrical extension (10) to the chamber (9), and then, to the tank inside, through the opening (34) on the lower cap (30), goes through the filtering elements, gets to the tank bottom and goes back through the tube (33), housed on the valve lower cap (30), penetrates the chamber (8) through the opening (37) on the lower cap (30), with the plunger (15) in the open position, the water goes through the cylindrical projection (11), and gets out through the tubular projection (4), to the use line (filtered water), with the plunger (15) in the closed position, the water will come out through the tubular projection (5) to the drain, this operation is usually made after Backwash, in order to eliminate residual water. To perform Backwash, the water enters the chamber (7) through the tubular projection (3), the plunger (13) shall be closing the passage (10), then the water goes to the chamber (8) through a passage (36), which connects to the chamber (7), in this case the plunger (14) shall be in the open position, allowing the water to pass through the cylindrical projection (12), after it enters the chamber (8) the water heads to the tube (33) housed on the lower cap (30), through the opening (37), goes down to the bottom of the tank and goes back through the filtering elements in an opposite flow to the Filtering flow, passing through the opening (38), it goes into the chamber (38A) and gets out through the tubular projection (6), Backwash outlet.

When the shaft (22) is driven by the handle (35), the plungers (13) (14) and (15) are placed in the desired flow configuration, as previously explained, on the shaft (22) end there is a positioning lock (39), composed of the lock (39) itself, a ball (40), pressed by a spring (41), this positioning lock (39) is intended for ensuring the flow configuration is maintained in the desired position, and the assembly moved by the handle (35) mandatorily rotates in only one direction (clockwise), in such a way that the sequence is always Backwash, Drainage and Filtration.

Finally, over the whole valve mechanism assembly, there is a cover (47), to protect it, which is movable, adapting to the side (45) or (46), to which the handle (35) is installed, and this cover (47) has, on its front portion, indications (48) of the operating configuration.

Those skilled in the art can now appreciate from the foregoing description that the broad teachings of the present invention can be implemented in a variety of forms, therefore, while this invention has been described in connection with particular examples thereof, the true scope of the invention should not be so limited since other modifications will become apparent to the skilled practitioner upon a study of the drawings, specification and following claims.

1. A single-controlled flow reversing valve for use with a fluid-containing tank, said reversing valve comprising:
an intermediate block having the shape of a parallelepiped, said block having four generally radial faces, each of said four faces having a tubular projection formed therein, said block having three substantially isolated chambers formed therein, each of said chambers having a cylindrical extension extending therefrom, said intermediate block having an upper side and a lower side;
an upper cap attachable to said upper side of said intermediate block;
three tubular projections formed on said upper cap and extending therefrom;
three fluid-blocking plungers fitted to said upper cap through said three tubular projections, each of said three cylindrical extensions having one of said plungers selectively fitted thereover, each plunger including a shaft and a sealing ring fitted thereto, each of said shafts being biased to an open position by a spring;
a first shaft being rotatably mounted on said upper cap, the shaft being operatively associated with said fluid-blocking plungers, said first shaft including three cams, each of said cams being operatively associated with each of said shafts of said plungers;
a second shaft being rotatably mounted on said upper cap;
a user-manipulated handle operatively associated with said second shaft, the second shaft being perpendicularly positioned relative to said first shaft, said first shaft including a conical drive element and said second shaft including a conical drive element, said conical drive elements being operatively associated with one another such that rotation of said second shaft effects rotation of said first shaft; and
a lower cap attachable to said lower side of said intermediate block, said lower cap having a cylindrical tubular projection extending therefrom for fluid attachment to the tank.

2. The single-controlled flow reversing valve of claim 1 wherein said intermediate block is formed from a reinforced polymerized material.

3. The single-controlled flow reversing valve of claim 1 wherein said upper cap and said lower cap have substantially the same profile as the intermediate block.

4. The single-controlled flow reversing valve of claim 1 further including a first set of bearings operatively associated with said first shaft and a second set of bearings operatively associated with said second shaft.

5. A single-controlled flow reversing valve for use with a fluid-containing tank, said reversing valve comprising:
an intermediate block having the shape of a parallelepiped, said block having four faces, each of said four faces having a tubular projection formed therein, said block having a plurality of substantially isolated chambers formed therein, each of said chambers having a cylindrical extension extending therefrom, said intermediate block having an upper side and a lower side;
an upper cap attachable to said upper side of said intermediate block;
a plurality of projections formed on said upper cap and extending therefrom;
a plurality of fluid-blocking plungers fitted to said upper cap through said tubular projections, each of said cylindrical extensions having one of said plungers selectively fitted thereover, each plunger including a shaft and a sealing member fitted thereto, each of said shafts being biased to an open position by a biasing element;
a first shaft being rotatably mounted on said upper cap, the shaft being operatively associated with said plurality of fluid-blocking plungers, said first shaft including a number of cams equivalent to the number of plungers and being operatively associated therewith;
a second shaft being rotatably mounted on said upper cap, said second shaft being perpendicularly positioned relative to said first shaft, said first shaft including a first drive element and said second shaft including a second drive element, said first and second drive elements being operatively associated with one another such that rotation of said second shaft effects rotation of said first shaft; and
a lower cap attachable to said lower side of said intermediate block, said lower cap having a cylindrical tubular projection extending therefrom for fluid attachment to the tank.

6. The single-controlled flow reversing valve of claim 5, wherein said four faces being generally radial.

7. The single-controlled flow reversing valve of claim 5, wherein said plurality of isolated chambers is defined by three isolated chambers.

8. The single-controlled flow reversing valve of claim 5, wherein said second shaft having a user-operator drive handle associated therewith.

9. The single-controlled flow reversing valve of claim 5, wherein said biasing element is a spring.

10. The single-controlled flow reversing valve of claim 5, wherein wherein said sealing member is a sealing ring.

11. The single-controlled flow reversing valve of claim 5, wherein said first and second drive elements are conical gears.

12. The single-controlled flow reversing valve of claim 5 wherein said intermediate block is formed from a reinforced polymerized material.

13. The single-controlled flow reversing valve of claim 5 wherein said upper cap and said lower cap have substantially the same profile as the intermediate block.

14. The single-controlled flow reversing valve of claim 5 further including a first set of bearings operatively associated with said first shaft and a second set of bearings operatively associated with said second shaft.

15. A single-controlled flow reversing valve comprising:
an intermediate block having the shape of a parallelepiped, said block having four faces, each of said four faces having a tubular projection formed therein, said block having a plurality of substantially isolated chambers formed therein, each of said chambers having a cylindrical extension extending therefrom, said intermediate block having an upper side and a lower side;
an upper cap attachable to said upper side of said intermediate block;
a plurality of fluid-blocking plungers fitted to said upper cap, each of said cylindrical extensions having one of said plungers selectively fitted thereover;
a first shaft being rotatably mounted on said upper cap, the shaft being operatively associated with said plurality of fluid-blocking plungers;
a second shaft being rotatably mounted on said upper cap, the second shaft being perpendicularly positioned relative to said first shaft and being operatively associated with said first shaft for causing rotation of the latter when the former is rotated; and
a lower cap attachable to said lower side of said intermediate block, said lower cap having a cylindrical tubular projection extending therefrom.

16. The single-controlled flow reversing valve of claim 15, wherein said first shaft includes a plurality of cams equal in number to the plurality of plungers.

17. The single-controlled flow reversing valve of claim 15, further including biasing elements to maintain said plungers in fluid-passing modes.

18. The single-controlled flow reversing valve of claim 15, wherein said intermediate block is formed from a reinforced polymerized material.

19. The single-controlled flow reversing valve of claim 15 wherein said upper cap and said lower cap have substantially the same profile as the intermediate block.

20. The single-controlled flow reversing valve of claim 15 further including a first set of bearings operatively associated with said first shaft and a second set of bearings operatively associated with said second shaft.
